(19) United States
(12) Patent Application Publication
(10) Pub. No.: US 2009/0280984 A1
(43) Pub. Date: Nov. 12, 2009

(54) Method of Inhibiting the Growth of Algae

(75) Inventor: Chih-Ta Kao, Ping Chen (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ITEQ CORPORATION, Ping Che (TW)

(21) Appl. No.: 12/115,748

(22) Filed: May 6, 2008

(51) Int. Cl. A01N 43/02

(52) U.S. Cl. 504/140

(57) ABSTRACT

To inhibit the growth of algae, glucosamine and chitosan are added into water needed to be treated wherein the concentration of glucosamine and chitosan in the treated water is in a ratio from 1:9 to 9:1.

### BACKGROUND

1. Field of Invention

The present invention relates to water treatment. More particularly, the present invention relates to growth inhibition of algae in water.

2. Description of Related Art

Many reservoirs around the world have water quality problems and one of the problems is nutrient pollution. Nutrient pollution comes from many sources, including fertilizer runoff from farms, livestock waste and inadequately treated sewage. Excessive nutrients such as nitrogen and phosphorus contribute algae matter in our water supplies.

Algae blooms can have a significant environmental impact due to the decrease in oxygen in the water, resulting in the die-off of fish and other organisms. Moreover, when disinfectants, such as chlorine, are added to drinking water supplies, chlorine combines with some algae to form disinfection by-products, trihalomethane. Trihalomethanes and other disinfection by-products, found in the tap water have been linked to cancer and birth defects. Furthermore, these algal blooms can produce significant quantities of natural toxins. Some algae, especially Cyanobacteria, produce either hepatotoxin or neurotoxin or even both. These toxins can cause severe dermatitis through skin contact, as well as gastrointestinal inflammation with oral exposure. Singly or in mixtures, these Cyanobacterial neurotoxins can cause death within minutes secondary to respiratory paralysis. At lower doses of hepatotoxin, enteritis and hepatitis are seen shortly after ingestion of these toxins.

In the conventional way, copper sulfate is probably the most widely used chemical application for controlling algae in water suppliers throughout the world. However, like other heavy-impact pollutants, copper accumulates in higher and higher concentrations as it moves up the food chain, and eventually leads to declines in fish and frog populations, according to several scientific studies. Short-term exposure to copper can lead to gastrointestinal distress, and long-term exposure causes liver or kidney damage. For the forgoing reasons, there is a need for inhibiting the growth of algae.

### SUMMARY

The present invention is directed to a method that inhibits the growth of algae without being hazard to human's health or the environment.

In one aspect, the present invention provides a method for inhibiting the growth of algae which comprises adding glucosamine and chitosan into water needed to be treated. The concentration of glucosamine and chitosan in the treated water is in a ratio from 1:9 to 9:1.

According to one embodiment of the invention, the algae inhibited by glucosamine is Cyanobacteria. More specifically, the algae inhibited by glucosamine is Microcystis aeruginosa.

In conclusion, glucosamine greatly inhibits algal growth. In addition, since glucosamine and chitosan are natural degradable and eatable compounds, they will not accumulate in the environment or be hazardous for human health after being used for a long time.

It is to be understood that both the foregoing general description and the following detailed description are by examples, and are intended to provide further explanation of the invention as claimed.

### DESCRIPTION OF THE EMBODIMENTS

Reference will now be made in detail to the present embodiments of the invention.

### Embodiment I

In the following embodiment, three specimens, chitosan, glucosamine, and the combination of both, were used as inhibitors to inhibit algal growth and their inhibition efficiency was tested as well. In this embodiment, one kind of toxic Cyanobacteria, Microcystis aeruginosa, is used for the inhibition test. Since chlorophyll-a content of algae is widely used as an indicator of the abundance of algae in a freshwater body, the chlorophyll-a content of Microcystis aeruginosa in the sample was detected by spectrometry.

First, four 0.5 ml portions of Microcystis aeruginosa solution were obtained and were labeled as sample I, II, III and IV, respectively, and 49.5 ml of Bold's medium was added to each sample. Next, chitosan, glucosamine, and the combination were added to sample II, III and IV, respectively, so that sample II contains 10 ppm chitosan, and sample III contains 10 ppm glucosamine, and sample IV contains 5 ppm chitosan and 5 ppm glucosamine. Sample I without any chitosan and glucosamine added was used as the control. After that, these four samples were cultured for 14 days. During that time, the Chlorophyll-a content of four samples were detected every 7 days according to the procedures mentioned below.

A portion of each sample was obtained and centrifuged at 10000 rpm at 20° C. for 15 mins, and then the supernatant was poured out. Next, four 10 ml portions of 95% (v/v) ethanol were added to sample I to IV and mixed with the residues. Next, the solution of each sample was water-bathed in 60° C. water for 30 mins to extract Chlorophyll-a. When being bathed in the water, the solution of each sample was shaken every ten minutes. After that, the solutions were centrifuged at 5000 G at 20° C. for 15 minutes and the supernatants were kept. Then, the absorbance at 665 nm of the control and sample I were detected. Finally, according to the “Standard Methods for the Examination Chlorophyll-a in Water-Ethanol Extraction” issued by National Institute of Environmental Analysis, Taiwan (NIEA E508.00B), the absorbance at 665 nm of samples I to IV were calibrated and the concentration of Chlorophyll-a content of each sample was calculated by the absorbance measured. The result is shown in Table 1.

TABLE 1
detection of Chlorophyll-a content

| | | Sample | | | |
|---|---|---|---|---|---|
| | | I | II | III | IV |
| Glucosamine (ppm) | | 0 | 0 | 10 | 5 |
| Chitosan (ppm) | | 0 | 10 | 0 | 5 |
| Chlorophyll-a | 0^{th} day | 6.9 | 6.9 | 6.9 | 6.9 |
| Content (ppb) | 7^{th} day | 278 | 95 | 33 | 12 |
| | 14^{th} day | 2470 | 1531 | 554 | 181 |

Refer to Table 1, it shows that the chlorophyll-a content in sample I (i.e. the control) without any inhibitor added was around 278 ppb after 7 days. By adding chitosan into sample II and adding glucosamine into sample III, the chlorophyll-a content in these two samples respectively decreased to 95 ppb and 33 ppb, which indicated that the growth of algae was inhibited by either chitosan or glucosamine. Surprisingly, the chlorophyll-a content in the sample IV containing both chitosan and glucosamine was the least, compared with samples I to II. It was only 12 ppb. Furthermore, 14 days later, the same effect was also shown. The chlorophyll-a content in sample I was the most, 2470 ppb. However, the chlorophyll-a content in sample II and III were less, only 1531 and 554 ppb. Again, the chlorophyll-a content in sample IV having both chitosan and glucosamine was the least, 181 ppb. Accordingly, the result of the embodiment of the present invention shows that both chitosan and glucosamine could inhibit the growth of algae. Moreover, while both chitosan and glucosamine are added in the solution, the algal growth is much more efficiently inhibited than that only chitosan or glucosamine is added.

### Embodiment II

According to the embodiment above, it has been proved that the mixture of chitosan and glucosamine could inhibit the algae growth. Hence, in the following embodiment, chitosan to glucosamine were combined in different ratios to examine how the inhibition efficiency affected by the different ratios of chitosan to glucosamine. Basically, the whole process was the same as mentioned above except the concentration of chitosan and glucosamine in samples, and the Chlorophyll-a content was also detected. The concentration of glucosamine and chitosan contained in each sample and the Chlorophyll-a content detected are show in Table 2.

TABLE 2
detection of Chlorophyll-a content

| | | Sample | | | | | | | | | | |
|---|---|---|---|---|---|---|---|---|---|---|---|---|
| | | Blank | a | b | c | d | e | f | g | h | i | j |
| Glucosamine (ppm) | | 0 | 10 | 9 | 8 | 7 | 6 | 5 | 4 | 3 | 2 | 1 |
| Chitosan (ppm) 0 | | 0 | 1 | 2 | 3 | 4 | 5 | 6 | 7 | 8 | 9 | |
| Chlorophyll-a | 7^{th} day | 62 | 50 | 0 | 0 | 0 | 0 | 0 | 0 | 0 | 0 | 0 |
| content (ppb) | 14^{th} day | 418 | 124 | 0 | 0 | 0 | 0 | 0 | 0 | 0 | 0 | 0 |

* the original chlorophyll-a content of Microcystis aeruginosa at the first day was 9.7 ppb.

The original chlorophyll-a content in each sample was 9.7 ppb and after a week, it increased to 62 ppb in the control. For sample (a), which contained only 10 ppm glucosamine, it inhibited growing of algae so that only 50 ppb of the chlorophyll-a was detected. As to samples (b)-(j), the concentration of glucosamine and chitosan contained was in a ratio from about 1:9 to 9:1, and the algae growth was inhibited very well so that the chlorophyll-a content in these nine samples was 0 ppb. After two weeks later, the chlorophyll-a content in the control and sample (a) reached to 418 ppb and 124 ppb, respectively, but it still maintained at 0 ppb in samples (b)-(j). Therefore, according to Table 2, it is found that although the ratio of glucosamine and chitosan is changed variously, the combination of both can still provide good inhibition efficiency while the concentration of glucosamine and chitosan contained is in a ratio from 1:9 to 9:1.

Accordingly, being a nature degradable and eatable compound, glucosamine and chitosan not only inhibit the algal growth successfully but are not harmful to the environment or human health after used for a long time. Moreover, the inhibition ability of the combination of glucosamine and chitosan is much more efficiency, compared with either glucosamine or chitosan individually.

Although the present invention has been described in considerable detail with reference and certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for inhibiting the growth of algae, comprising:
adding glucosamine and chitosan into water needed to be treated.

2. The method of claim 1, wherein the concentration of glucosamine and chitosan in the water is in a ratio from 1:9 to 9:1.

3. The method of claim 1, wherein the concentration of the glucosamine in the water is at least 1 ppm.

4. The method of claim 1, wherein the concentration of the chitosan in the water is at least 1 ppm.

5. The method of claim 1, wherein the algae inhibited is Cyanobacteria.

6. The method of claim 1, wherein the algae inhibited is Microcystis aeruginosa.
